(19) United States
(12) Patent Application Publication
(10) Pub. No.: US 2016/0234708 A1
(43) Pub. Date: Aug. 11, 2016

(54) EXPEDITED SYSTEM INFORMATION COLLECTION DURING REDIRECTION

(71) Applicant: QUALCOMM Incorporated, San Diego, CA (US)

(72) Inventors: Ming YANG, San Diego, CA (US); Tom CHIN, San Diego, CA (US); Shaohong QU, San Diego, CA (US)

(21) Appl. No.: 14/615,329

(22) Filed: Feb. 5, 2015

(51) Int. Cl. H04W 24/10; H04W 72/04; H04W 48/16

(52) U.S. Cl. CPC H04W 24/10; H04W 48/16; H04W 72/042

(57) ABSTRACT

A user equipment (UE) reduces latency during a redirection procedure, such as a circuit-switched fallback (CSFB) procedure. In one instance, the UE searches and measures each frequency of a received redirection list of frequencies to determine a strongest frequency. The UE decodes a system information block (SIB) from one or more non-strongest frequencies. The UE then determines whether to wait for a system information block from the strongest frequency based on a metric. The UE determines which of the one or more non-strongest frequencies are selected based on the metric when deciding not to wait for the system information block from the strongest frequency.

### BACKGROUND

1. Field

Aspects of the present disclosure relate generally to wireless communication systems, and more particularly, to a selection of a non-strongest cell to reduce latency of redirection from one radio access technology (RAT) to another RAT when system information for a strongest cell arrives later than the system information of the non-strongest cell.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes searching and measuring each frequency of a received redirection list of frequencies to determine a strongest frequency. The method also includes decoding a system information block (SIB) from one or more non-strongest frequencies. The method also includes determining whether to wait for a system information block from the strongest frequency based on a metric. The method further includes determining which of the one or more non-strongest frequencies is selected based on the metric when deciding not to wait for the system information block from the strongest frequency.

According to another aspect of the present disclosure, an apparatus for wireless communication includes means for searching and measuring each frequency of a received redirection list of frequencies to determine a strongest frequency. The apparatus may also include means for decoding a system information block (SIB) from one or more non-strongest frequencies. The apparatus may also include means for determining whether to wait for a system information block from the strongest frequency based on a metric. The apparatus further includes means for determining which of the one or more non-strongest frequencies is selected based on the metric when deciding not to wait for the system information block from the strongest frequency.

Another aspect discloses an apparatus for wireless communication and includes a memory and at least one processor coupled to the memory. The processor(s) is configured to search and measure each frequency of a received redirection list of frequencies to determine a strongest frequency. The processor(s) is also configured to decode a system information block (SIB) from one or more non-strongest frequencies. The processor(s) is also configured to determine whether to wait for a system information block from the strongest frequency based on a metric. The processor(s) is further configured to determine which of the one or more non-strongest frequencies is selected based on the metric when deciding not to wait for the system information block from the strongest frequency.

Yet another aspect discloses a computer program product for wireless communications in a wireless network having a non-transitory computer-readable medium. The computer-readable medium has non-transitory program code recorded thereon which, when executed by the processor(s), causes the processor(s) to search and measure each frequency of a received redirection list of frequencies to determine a strongest frequency. The program code also causes the processor(s) to decode a system information block (SIB) from one or more non-strongest frequencies. The program code also causes the processor(s) to determine whether to wait for a system information block from the strongest frequency based on a metric. The program code further causes the processor(s) to determine which of the one or more non-strongest frequencies is selected based on the metric when deciding not to wait for the system information block from the strongest frequency.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a user equipment (UE) in a telecommunications system.

FIG. 4 illustrates network coverage areas according to aspects of the present disclosure.

FIG. 5 is a call flow diagram conceptually illustrating an example process for expedited system information collection during redirection according to one aspect of the present disclosure.

FIG. 6 is an exemplary graph conceptually illustrating an example of system information collection during redirection according to one aspect of the present disclosure.

FIG. 7 is a block diagram illustrating a method for wireless communication according to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

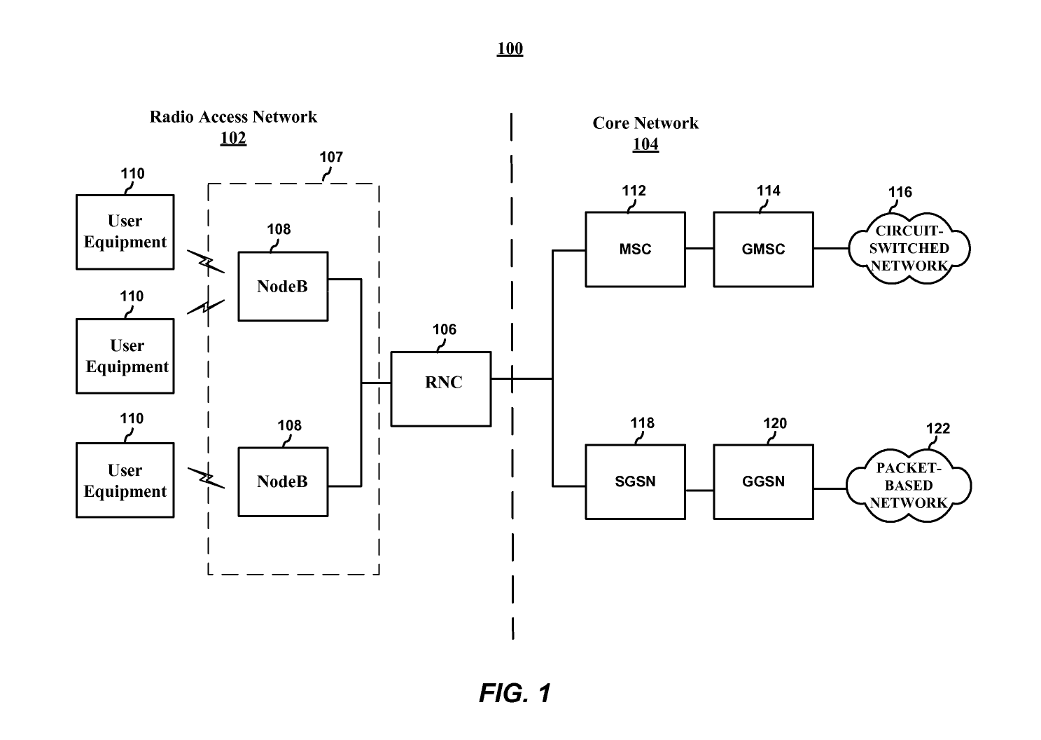

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

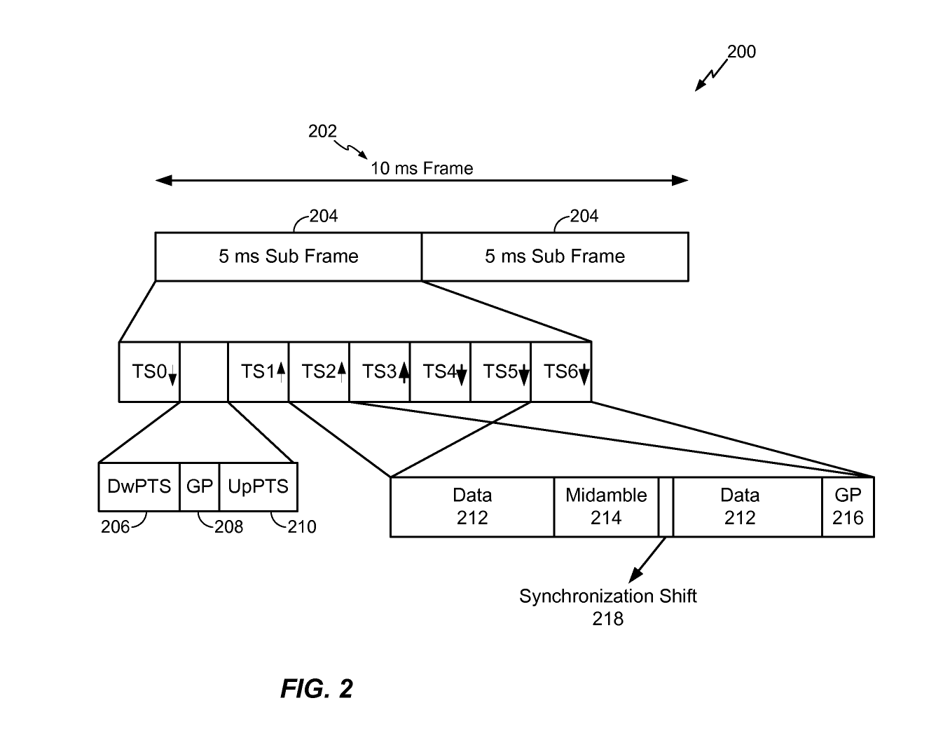

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TSO through TS6. The first time slot, TSO, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

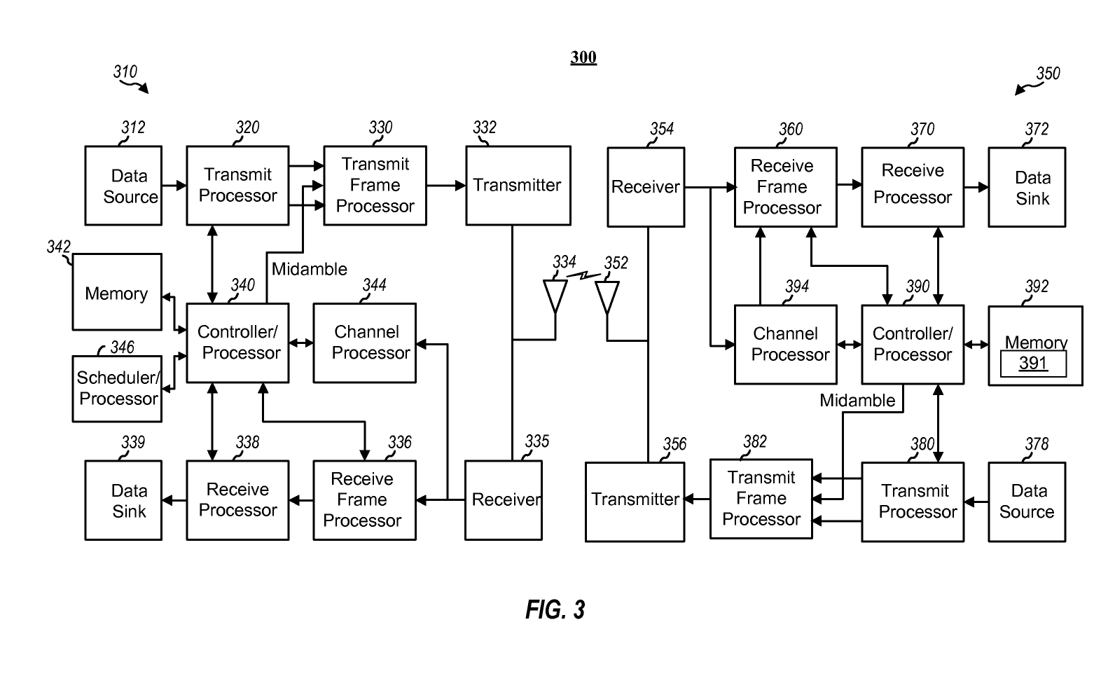

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a redirection module 391 which, when executed by the controller/processor 390, configures the UE 350 for the expedited system information collection implementation according to aspects of the present disclosure. A scheduler/processor 346 at the node B 310 may be used to allocate resources to the UEs and schedule downlink and/or uplink transmissions for the UEs.

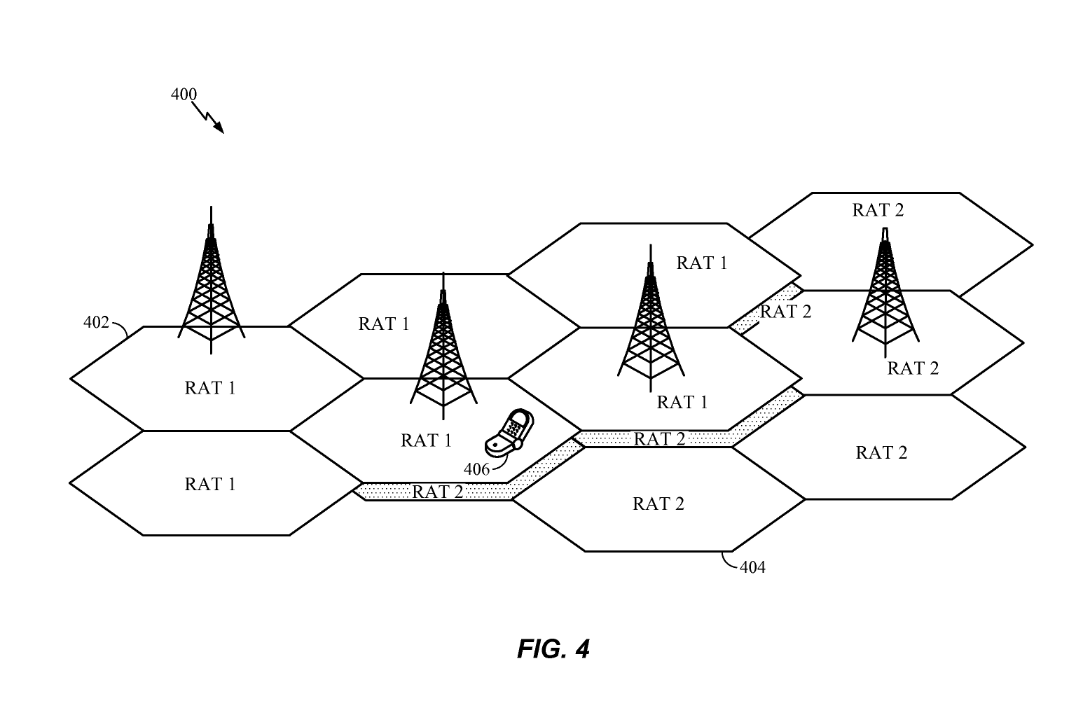

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may be redirected from a first RAT, such as a RAT-2 cell 404, to another RAT, such as a RAT-1 cell 402.

In some instances, when the UE is in a connected mode or idle mode with a serving RAT, the UE may be redirected to a target RAT to initiate or receive a voice call. Redirection from one RAT to another RAT is commonly used to perform operations such as load balancing or circuit-switched fallback (CSFB) from one RAT to another RAT. For example, one of the RATs may be long term evolution (LTE) while the other RAT may be universal mobile telecommunications system—frequency division duplexing (UMTS FDD), universal mobile telecommunications system—time division duplexing (UMTS TDD), or global system for mobile communications (GSM). In some aspects, the redirection may be from a frequency or cell of one RAT to a frequency or cell of the same RAT.

Circuit-switched fallback is a feature that enables multimode user equipments (UEs) that are capable of communicating on a first RAT (e.g., LTE) in addition to communicating on a second RAT (e.g., second/third generation (2G/3G) RAT) to obtain circuit-switched voice services while being camped on the first RAT. For example, the circuit-switched fallback capable UE may initiate a mobile-originated (MO) circuit-switched voice call while on LTE. Because of the mobile-originated circuit-switched voice call, the UE is redirected to a circuit-switched capable RAT. For example, the UE is redirected to a radio access network (RAN), such as a 3G/2G network, for the circuit-switched voice call setup. In some instances, the circuit-switched fallback capable UE may be paged for a mobile-terminated (MT) voice call while on LTE, which results in the UE being moved to 3G or 2G for the circuit-switched voice call setup.

A user equipment (UE) may receive a circuit-switched (CS) page from a first base station of a first radio access technology (RAT) or initiate a circuit-switched call to the first base station. For example, a circuit-switched fallback capable UE may be paged for a mobile-terminated (MT) voice call while on the first RAT (e.g., long term evolution (LTE)) or may initiate a mobile-originated (MO) circuit-switched voice call while the UE is in LTE connected or idle mode. In response to the page, the UE is redirected to a second RAT (e.g., third generation (3G)/second generation (2G)) to set up the circuit-switched voice call. For example, to set up the circuit-switched voice call on the second RAT, the UE may receive a connection release message from a base station of the first RAT. The connection release message may include redirection information that indicates the RAT (e.g., target base station of a second RAT), frequency and/or cell to which the UE is to be redirected for the circuit-switched fallback call. The redirection information may also include system information. For example, the redirection information may include base station identifiers with associated system information, a list of frequencies, cell IDs and broadcast system information, such as MIBs and/or SIBs (master information blocks and/or system information blocks). In some instances, however, the connection release message may not include the redirection information.

Various methods are utilized in an attempt to reduce latency that occurs during circuit-switched fallback call (CFSB) setup. For example, system information block (SIB) tunneling and deferred measurement control reading (DMCR) may be introduced to reduce latency for call setup. For circuit-switched fallback to UTRAN, the delay related to call setup may increase due to additional signaling on both the LTE and UTRAN sides. A substantial part of the call setup delay results from reading system information on the circuit-switched RAT prior to the access procedure. After completing the collection of system information, the UE begins the access procedure to set up the circuit-switched call in the circuit-switched RAT.

Call establishment latency is a factor used to evaluate circuit-switched fallback performance. The UE cannot perform power scans on all of the frequencies deployed for operators because a full power scan may take twenty or more seconds, which is not accepted under circuit-switched fallback call latency performance specifications.

When a UE receives a radio resource control (RRC) release message (LTE release message) with a redirection command, the redirection command may include a list of frequencies. For example, the redirection command may include a list of 2G/3G (e.g., GSM or TD-SCDMA) absolute radio-frequency channel numbers (ARFCNs). The UE performs a power scan for all of the frequencies (e.g., GSM ARFCNs) in the list. The UE determines which are the strongest signals and ranks the frequencies in order of signal quality.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc. Signal quality is intended to cover the term signal strength, as well.

In some scenarios, the UE only ranks the frequencies having a signal quality above a threshold. The signal quality may be based on received signal strength indicators of the frequencies. For example, when the received signal strength indicator of a GSM channels is above a threshold, the UE performs a frequency correction channel/synchronization channel (FCCH/SCH) decoding to obtain frame numbers. The decoding may be performed based on the ranking of the channels. In one example, the UE only decodes the FCCH/SCH of the strongest GSM channel.

Based on the frame numbers carried in the synchronization channel, the UE calculates an arrival time of a broadcast control channel (BCCH), which includes a system information block (e.g., SIB 3, SIB 4). The SIB 3 includes a public land mobile network (PLMN) identification, and the minimal received signal strength indicator level for camping and a barred status. SIB 4 indicates a location area code.

If there is sufficient time before the arrival of the broadcast control channel of the strongest GSM channel, the UE also decodes the FCCH/SCH of other GSM channels in order of signal quality. For example, the UE decodes a second, third, and/or fourth strongest GSM channels, and then calculates a BCCH arrival time for each of these GSM channels.

In some instances, however, the BCCH for GSM channels other than the strongest GSM channel (e.g., second, third, fourth strongest GSM channel), arrives much earlier than the BCCH of the strongest GSM channel. The current procedure is that after the UE decodes the BCCHs of the non-strongest GSM channels and determines that one of the channels is suitable for the UE to camp on, the UE still waits for the arrival of the BCCH of the strongest channel. As a result of the wait, the circuit-switched fallback call setup latency is increased.

### Expedited System Information Collection During Redirection

One aspect of the present disclosure is directed to reducing latency during a redirection procedure, such as a circuit-switched fallback procedure. In one aspect of the disclosure, a user equipment (UE) may receive a redirection list including a list of frequencies and/or cells to search for circuit-switched fallback (CSFB) or redirection. The UE then searches and measures each frequency in the list to determine a strongest frequency and/or cell. The UE then decodes a system information block (e.g., SIB 3 and SIB 4) from one or more non-strongest frequencies.

The UE may determine whether to collect system information from a stronger frequency and/or cell based on a metric. For example, the UE may determine whether to wait for a system information block (SIB), such as SIB 3 or SIB 4, from the stronger frequency based on the metric. An example metric is an absolute signal quality value and/or threshold of a non-strongest frequency. An absolute signal quality threshold may be based on UE receiver performance. For example, when the UE performance is good, the threshold of the absolute signal quality is low. Otherwise, when the UE performance is poor, the threshold of the absolute signal quality is high. The metric may also be based on a difference in expected system information block arrival time for different frequencies or a difference in signal quality between the different frequencies

In one aspect of the disclosure, the UE does not wait for the arrival of the broadcast channel (e.g., BCCH) (or the system information block) from the strongest GSM channel when the difference in signal strengths (e.g., as measured by RSSI) between the strongest GSM channel and the second, third, and/or fourth strongest GSM channels is below a predefined threshold (e.g., 3 dB).

Further, the UE does not wait for the arrival of the BCCH from the strongest GSM channel when the BCCH for the second, third, and/or fourth strongest GSM channel arrives earlier than the BCCH for the strongest GSM channel.

Furthermore, the UE does not wait for the arrival of the BCCH for the strongest GSM channel when the arrival time difference between the BCCH of the strongest GSM channel and the BCCH for the second, third, and/or fourth strongest GSM channel is above another predefined threshold.

When the UE decides not to wait for the arrival of the BCCH for the strongest GSM channel, the UE determines which non-strongest frequency is selected based on the metric. The UE then performs a cell selection procedure based on the selected second, third, or fourth strongest GSM channel, after successfully decoding its BCCH.

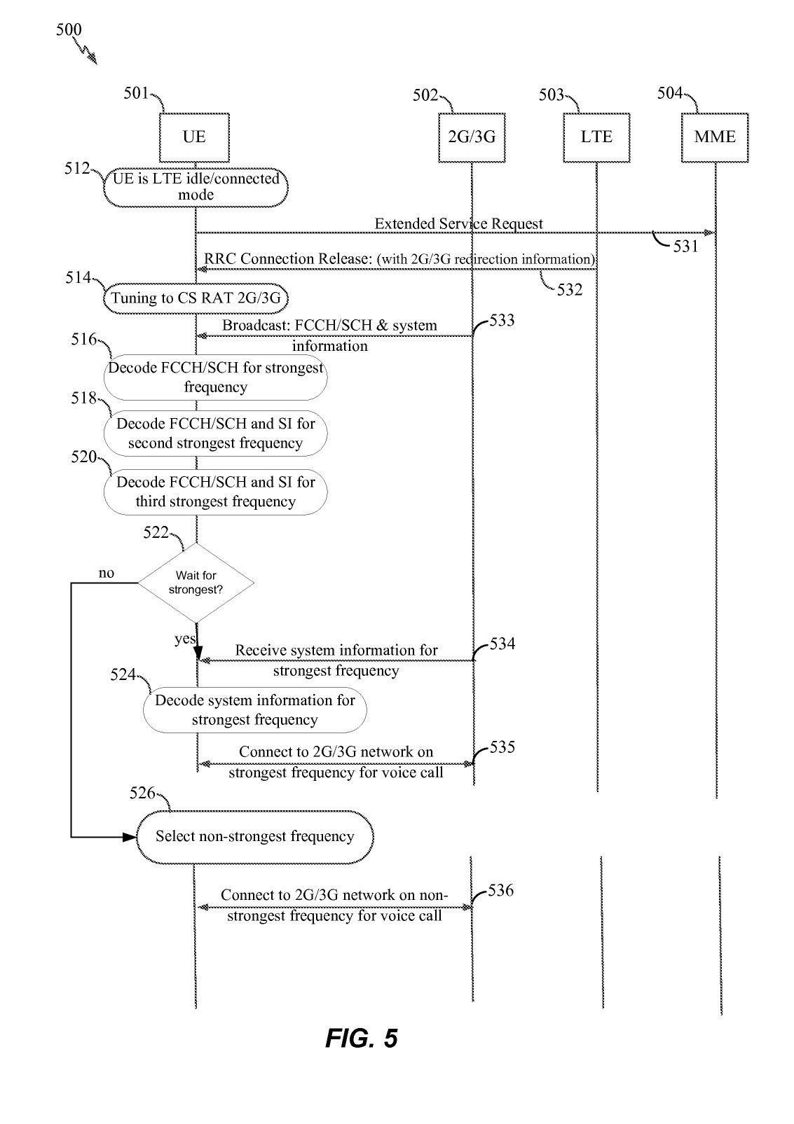

FIG. 5 is a call flow diagram conceptually illustrating an example process for expedited system information collection during redirection according to one aspect of the present disclosure. A user equipment (UE) 501 at time 512 may be camped on an LTE network 503. Then, the UE 501 may originate or receive a voice call and a redirection procedure may be invoked to service the voice call.

In this example, the UE 501 is a multimode, circuit-switched fallback-capable UE with 2G/3G and LTE capabilities. The UE 501 may use the circuit-switched fallback feature for circuit-switched voice services while being camped on the LTE network 503. The UE 501 may be paged for a mobile-terminated (MT) voice call or may initiate a mobile-originated (MO) voice call while camped on the LTE network 503. In response to the voice call, the UE 501 moves to a 2G/3G network 502 for circuit-switched voice call setup. For example, at time 531, the UE 501 sends an extended service request (ESR) to a mobility management entity (MME) 504 to initiate a redirection for a circuit-switched fallback service.

To set up the circuit-switched voice call on the 2G/3G network 502, the UE may receive a connection release message (e.g., LTE radio resource control (RRC) release message) from the LTE network 503. For example, at time 532, the LTE network 503 sends a radio resource connection (RRC) connection release message with 2G/3G redirection information to initiate a redirection to the circuit-switched fallback-capable 2G/3G network 502. When the UE receives the LTE radio resource control (RRC) release message with a redirection command, the redirection command may include a list of frequencies. For example, the redirection command may include a list of 2G/3G frequencies. The UE performs a power scan for all of the frequencies (e.g., GSM ARFCNs) in the list. The UE determines which are the strongest signals and ranks the frequencies in order of signal quality. The UE then searches and measures each frequency in the list to determine a strongest frequency and/or to rank the frequencies/cells.

At time 514, as part of redirection to the 2G/3G network 502, the UE 501 tunes to a 2G/3G radio access technology (RAT) to acquire information about the 2G/3G network 502. At time 533, the 2G/3G network 502 broadcasts information, including frequency correction channels, synchronization channels (FCCHs/SCHs) and system information on a 2G/3G RAT broadcast channel. At time 516, the UE 501 decodes the synchronization channel and frequency correction channel (FCCH/SCH) from the strongest frequency to calculate when system information (e.g., SIBs) is scheduled for the strongest 2G/3G frequency.

The UE may also decode the FCCH/SCH as well as system information (e.g., SIBS) from one or more non-strongest frequencies while waiting for the strongest frequency system information. For example, the system information from the strongest frequency may be scheduled after the non-strongest FCCHs/SCHs and system information arrive. Accordingly, the UE decodes the FCCHs/SCHs and system information from non-strongest frequencies that are received while waiting for the strongest frequency system information. For example, at time 518 and 520, the UE decodes the FCCHs/SCHs from the second and third strongest channels, respectively.

In one aspect of the disclosure, the UE may determine whether to continue to wait for system information from a strongest frequency based on a metric, at time 522.

For example, the UE may determine whether to wait for a system information block (SIB), such as SIB 3 or SIB 4, from the strongest frequency based on the metric.

When the UE decides to collect system information from the strongest frequency, the UE waits for a broadcast channel carrying the system information for the strongest frequency, at time 534. At time 524, the UE decodes the system information of the strongest frequency. The UE subsequently connects to the strongest frequency of the 2G/3G network 502 for the voice call, at time 535.

When the UE decides not to wait for the arrival of the system information for the strongest frequency, the UE determines which non-strongest frequency is selected based on the metric, at time 526. The UE may decide to select a non-strongest frequency based on signal strengths of the non-strongest frequencies and/or the times when the non-strongest frequency system information is scheduled. The UE then performs a cell selection procedure to the second or third strongest frequency. The UE subsequently connects to the 2G/3G network 502 via the selected frequency for the voice call, at time 536.

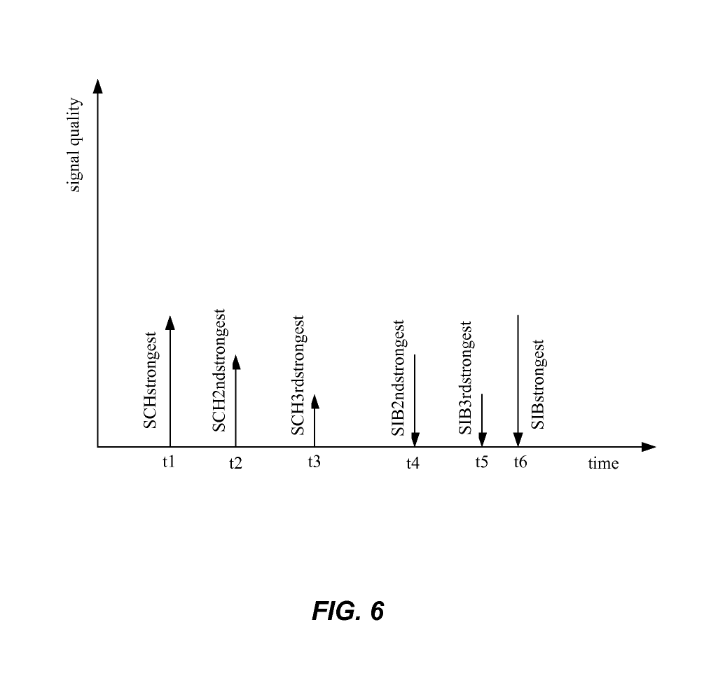

FIG. 6 is an exemplary graph conceptually illustrating an example system information collection during redirection according to aspects of the present disclosure. The x-axis illustrates time and the y-axis illustrates signal quality of each of the frequencies. For example, the x-axis illustrates a time that the synchronization channel (FCCH/SCH) for each of the frequencies is decoded and a time that the broadcast channel (or system information block carried in the broadcast channel) is decoded for each of the frequencies. In FIG. 6, the UE performs frequency correction channel/shared channel (FCCH/SCH) decoding to enable calculation of when the system information will arrive.

The decoding may be performed based on the ranking of the frequencies. For example, the UE first decodes the FCCH/SCH of the strongest frequency. If there is sufficient time before the arrival of the system information block of the strongest frequency, the UE also decodes the FCCH/SCH of other frequencies in order of signal quality Ming—please confirm this is accurate. For example, the UE decodes the FCCH/SCH of the second strongest frequency, at time t2. The UE next decodes the FCCH/SCH of the third strongest frequency, at time t3. After decoding the FCCH/SCH, the UE is able to calculate a system information arrival time for each of the corresponding frequencies.

In some instances, however, the system information block for frequencies other than the strongest frequency (e.g., second and third frequencies), arrives earlier than the system information block of the strongest frequency. In the example of FIG. 6, the system information block for the second and third strongest frequencies arrives earlier than the system information block for the strongest frequency. Accordingly, the system information block for the second and third strongest frequencies is decoded before the system information block for the strongest frequency. For example, the system information block for the second and third strongest frequencies is decoded at earlier times t4 and t5, respectively. The system information block for the strongest frequency, however, is decoded at a later time, t6. In some implementations, the UE waits for the arrival of the system information block of the strongest frequency before the selection procedure. Because of the wait, the circuit-switched fallback call setup latency is increased.

In one aspect of the disclosure, the UE may determine whether to wait for the arrival of the broadcast channel (or the system information block) from the strongest frequency based on a metric. When the UE decides not to wait for the arrival of the system information block for the strongest frequency, the UE determines which non-strongest frequency is selected based on the metric. For example, the decision may be based on the absolute signal quality of the non-strongest frequency. In this example, if the non-strongest signal quality exceeds a threshold, it will be selected. In another configuration, the decision is based on a difference between the signal quality of the non-strongest and strongest frequencies. If the difference is less than a threshold, the non-strongest frequency is selected. In still another configuration, the decision is based on the arrival times of the strongest and non-strongest frequencies. If the non-strongest frequency SIB (time t4) is scheduled much earlier than the strongest SIB (time t6), the UE selects the non-strongest frequency. In one aspect of the disclosure, the difference in arrival time may be compared to a relative time threshold. For example, if the difference in expected system information block arrival time for the strongest frequency and/or cell and the non-strongest frequency and/or cell is above the relative time threshold, the UE selects the non-strongest frequency. Otherwise, the UE may wait to select the strongest frequency.

In the example of FIG. 6, the signal quality difference between the second non-strongest SIB and the strongest frequency SIB is relatively small, and the second strongest SIB arrives significantly earlier than the strongest SIB, thus favoring selection of the second strongest frequency. The UE then performs a cell selection procedure based on the selected second strongest frequency

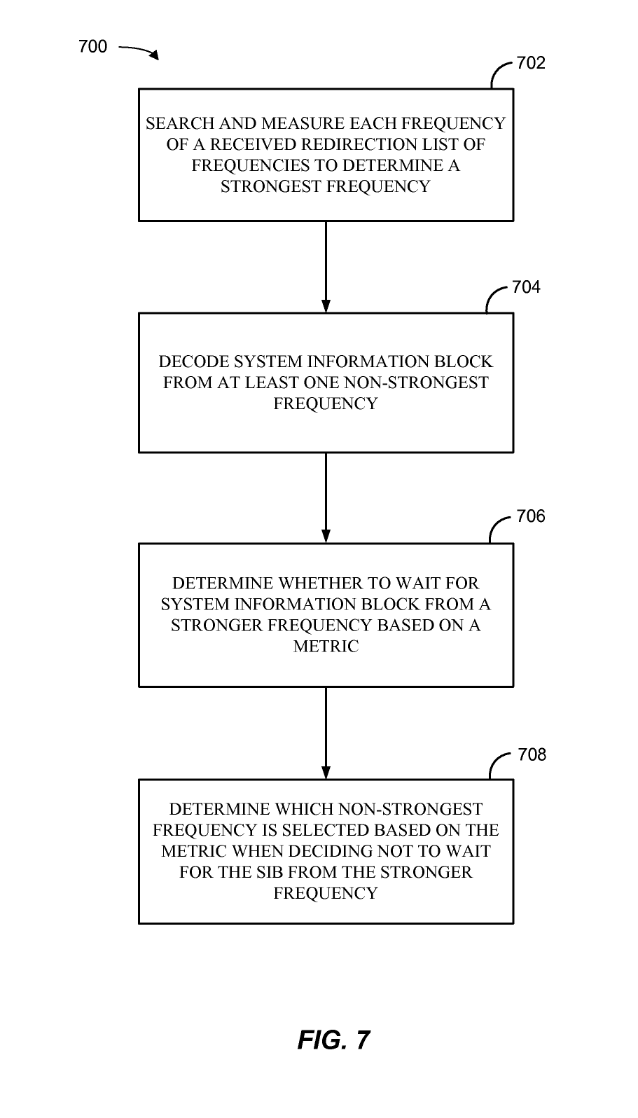

FIG. 7 shows a wireless communication method 700 according to one aspect of the disclosure. A user equipment (UE) searches and measures each frequency of a received redirection list of frequencies to determine a strongest frequency, as shown in block 702. The UE decodes a system information block (SIB) from one or more non-strongest frequency, as shown in block 704. In addition, the UE determines whether to wait for a system information block from a stronger frequency based on a metric, as shown in block 706. Finally, the UE determines which non-strongest frequency is selected based on the metric when deciding not to wait for the SIB from the stronger frequency, as shown in block 708.

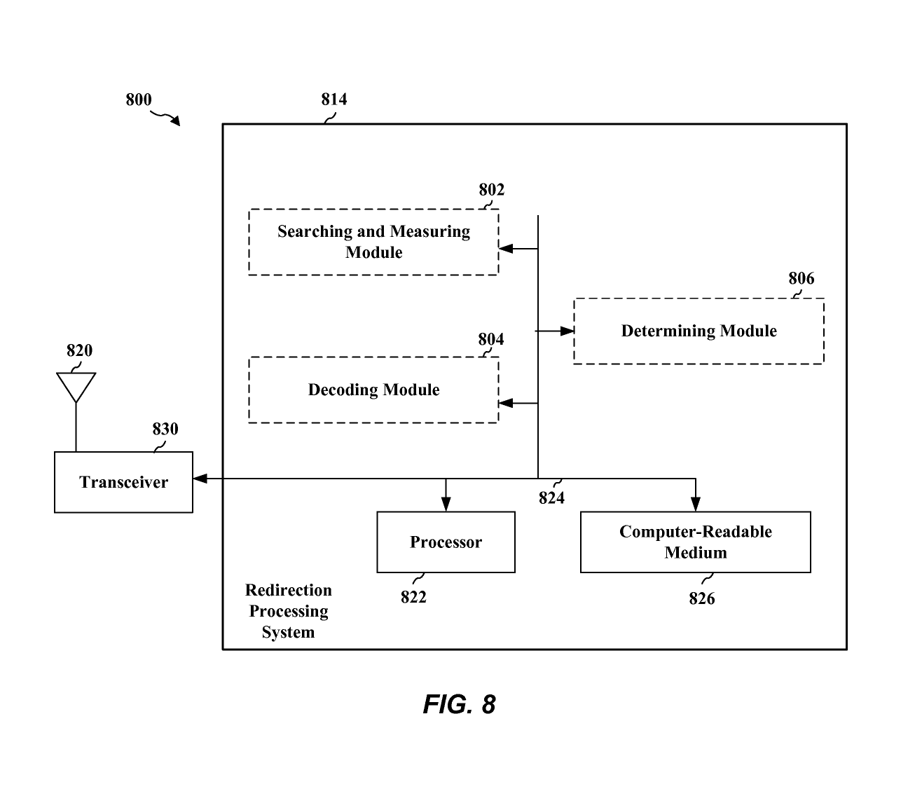

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804, 806 and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatuses over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a searching and measuring module 802 for searching and measuring each frequency of a received redirection list of frequencies to determine a strongest frequency. The processing system 814 also includes a decoding module 804 for decoding a system information block (SIB) from one or more non-strongest frequency. The processing system 814 also includes a determining module 806 for determining whether to wait for a system information block from a stronger frequency based on a metric. The determining module 806 also determines which non-strongest frequency is selected based on the metric when deciding not to wait for the SIB from the stronger frequency. The modules may be software modules running in the processor 822, resident/stored in the computer-readable medium 826, one or more hardware modules coupled to the processor 822, or some combination thereof. The processing system 814 may be a component of the UE 350 and may include the memory 392, and/or the controller/processor 390.

The UE is configured to include means for searching and measuring. In one aspect, the searching and measuring means may be the antennas 352/820, the receiver 354, the transceiver 830, the channel processor 394, the receive frame processor 360, the receive processor 370, the controller/processor 390, the memory 392, the redirection module 391, the searching and measuring module 802, and/or the processing system 814 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE is configured for wireless communication including means for decoding. In one aspect, the decoding means may be the antennas 352/820, the receiver 354, the transceiver 830, the channel processor 394, the receive frame processor 360, the receive processor 370, the controller/processor 390, the memory 392, the redirection module 391, the decoding module 804, and/or the processing system 814 configured to perform the aforementioned means. In another aspect, the aforementioned means may be a module or any apparatus configured to perform the functions recited by the aforementioned means.

The UE is also configured to include means for determining. In one aspect, the determining means may be the channel processor 394, the receive frame processor 360, the receive processor 370, the transmit frame processor 382, the transmit processor 380, the controller/processor 390, the memory 392, the redirection module 391, the determining module 806 and/or the processing system 814 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system have been presented with reference to LTE, TD-SCDMA and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
searching and measuring each frequency of a received redirection list of frequencies to determine a strongest frequency;
decoding a system information block (SIB) from at least one non-strongest frequency;
determining whether to wait for a system information block from the strongest frequency based at least in part on a metric; and
determining which of the at least one non-strongest frequency is selected based at least in part on the metric when deciding not to wait for the system information block from the strongest frequency.

2. The method of claim 1, in which the metric comprises an absolute signal quality value of a non-strongest frequency.

3. The method of claim 2, in which the absolute signal quality value is based at least in part on user equipment (UE) receiver performance.

4. The method of claim 1, in which the metric is based at least in part on whether a difference in expected system information block arrival time for different frequencies is above a threshold.

5. The method of claim 1, in which the metric is based on whether a difference in signal quality between different frequencies is above a threshold.

6. The method of claim 5, in which the metric is based on whether the difference in signal quality between a selected non-strongest frequency and the strongest frequency or between the selected non-strongest frequency and another non-strongest frequency is above the threshold.

7. An apparatus for wireless communication, comprising:
means for searching and measuring each frequency of a received redirection list of frequencies to determine a strongest frequency;
means for decoding a system information block (SIB) from at least one non-strongest frequency;
means for determining whether to wait for a system information block from the strongest frequency based at least in part on a metric; and
means for determining which of the at least one non-strongest frequency is selected based at least in part on the metric when deciding not to wait for the system information block from the strongest frequency.

8. The apparatus of claim 7, in which the metric comprises an absolute signal quality value of a non-strongest frequency.

9. The apparatus of claim 8, in which the absolute signal quality value is based at least in part on user equipment (UE) receiver performance.

10. The apparatus of claim 7, in which the metric is based at least in part on whether a difference in expected system information block arrival time for different frequencies is above a threshold.

11. The apparatus of claim 7, in which the metric is based on whether a difference in signal quality between different frequencies is above a threshold.

12. The apparatus of claim 11, in which the metric is based on whether the difference in signal quality between a selected non-strongest frequency and the strongest frequency or between the selected non-strongest frequency and another non-strongest frequency is above the threshold.

13. An apparatus for wireless communication, comprising:
a memory; and
at least one processor coupled to the memory and configured:
to search and measure each frequency of a received redirection list of frequencies to determine a strongest frequency;
to decode a system information block (SIB) from at least one non-strongest frequency;
to determine whether to wait for a system information block from the strongest frequency based at least in part on a metric; and
to determine which of the at least one non-strongest frequency is selected based at least in part on the metric when deciding not to wait for the system information block from the strongest frequency.

14. The apparatus of claim 13, in which the metric comprises an absolute signal quality value of a non-strongest frequency.

15. The apparatus of claim 14, in which the absolute signal quality value is based at least in part on user equipment (UE) receiver performance.

16. The apparatus of claim 13, in which the metric is based at least in part on whether a difference in expected system information block arrival time for different frequencies is above a threshold.

17. The apparatus of claim 13, in which the metric is based on whether a difference in signal quality between different frequencies is above a threshold.

18. The apparatus of claim 17, in which the metric is based on whether the difference in signal quality between a selected non-strongest frequency and the strongest frequency or between the selected non-strongest frequency and another non-strongest frequency is above the threshold.

19. A computer program product for wireless communication, comprising:
a non-transitory computer-readable medium having program code recorded thereon, the program code comprising:
program code to search and measure each frequency of a received redirection list of frequencies to determine a strongest frequency;
program code to decode a system information block (SIB) from at least one non-strongest frequency;
program code to determine whether to wait for a system information block from the strongest frequency based at least in part on a metric; and
program code to determine which of the at least one non-strongest frequency is selected based at least in part on the metric when deciding not to wait for the system information block from the strongest frequency.

20. The computer program product of claim 19, in which the metric comprises an absolute signal quality value of a non-strongest frequency.

21. The computer program product of claim 20, in which the absolute signal quality value is based at least in part on user equipment (UE) receiver performance.

22. The computer program product of claim 19, in which the metric is based at least in part on whether a difference in expected system information block arrival time for different frequencies is above a threshold.

23. The computer program product of claim 19, in which the metric is based on whether a difference in signal quality between different frequencies is above a threshold.

24. The computer program product of claim 23, in which the metric is based on whether the difference in signal quality between a selected non-strongest frequency and the strongest frequency or between the selected non-strongest frequency and another non-strongest frequency is above the threshold.
